(19) United States
(12) Patent Application Publication
(10) Pub. No.: US 2007/0217515 A1
(43) Pub. Date: Sep. 20, 2007

(54) Method for determining a search pattern for motion estimation

(76) Inventors: Yu-Jen Wang, Taipei City (TW); Tian-Sheuan Chang, Hsinchu City (TW); Tse-Ming Chang, Ping-Tung County (TW)

Correspondence Address: NORTH AMERICA INTELLECTUAL PROPERTY CORPORATION, P.O. BOX 506, MERRIFIELD, VA, 22116, US

(21) Appl. No.: 11/308,281

(22) Filed: Mar. 15, 2006

(51) Int. Cl. H04N 11/04

(52) U.S. Cl. 375/240.17; 375/240.24

(57) ABSTRACT

A method for determining a search pattern for use in fractional motion estimation for video compression includes selecting a search center within a current macroblock; selecting a plurality of search points forming a half-pel search pattern surrounding the search center, and further selecting another search point at the search center; calculating a cost value for each search point according to a first cost function; and selecting a quarter-pel search pattern according to the cost values of at least two search points, the half-pel search pattern and the quarter-pel search pattern forming the search pattern. The search pattern is used in a matching process to determine a similarity of the current macroblock to a reference macroblock in a video undergoing compression.

### BACKGROUND OF THE INVENTION

1. Field of the Invention

This invention relates to image processing, more particularly, to a method for determining a search pattern used in motion estimation for video compression.

2. Description of the Prior Art

With modern day advances in computer processing and multimedia applications, improvements in the area of image processing and video compression are analogous. Video compression allows the reduction of high-resolution video into a more compact memory space to thereby reduce storage and video processing resources during playback. Reduced memory requirements for video footage can aid in lengthy video segments being stored onto portable media to and improve the mobility and transferability of large files. Bandwidth is also increased when performing file transfers, as quicker download and upload times are achieved through Internet and other transfer protocols.

Videos are produced through a series of different frames (or images) played in sequence. Therefore, the area of video compression reduces down to specialized forms of image compression with specific consideration for video playback. The art of video compression tends to fall into one of two categories: lossless compression and lossy compression. Lossy compression entails the reduction of certain finer image details that are sacrificed for the sake of saving a little more bandwidth or storage space. Lossless compression, on the other hand, involves compressing data such that it will be an exact replica of the original data upon decompression. For many types of binary data, such as documents and various programs, lossless compression is required as the integrity of the original data needs to be preserved. Many types of multimedia, on the other hand, need not be reproduced exactly as before. An approximation of the original image is usually sufficient for most purposes, as long as the error between the original and the compressed image is tolerable.

In performing lossy compression, a common technique is to remove redundant information between adjacent frames to reduce memory constraints and increase bandwidth. This technique is referred to as motion estimation (ME), of which H.264 and MPEG-4 are the current known standards. These standards exploit and remove temporal redundancies between successive frames, or more simply, select a reference frame and predict subsequent frames based on the reference frame. Motion estimation makes the assumption that the objects in the scene solely possess translational motion. This assumption holds as long as there is no pan, zoom, changes in luminance, or rotational motion. Motion estimation is an intensive process which generally consumes 60-90% of the computational time of a related encoder or micro-controller.

The ME process begins first by dividing the current frame into macroblocks. The size of a macroblock is typically 16×16 pixels, but can vary for each ME technique according to the desired tradeoff between resolution and computational cost. Each macroblock of a current frame is compared to a macroblock of a reference frame by calculating a cost value for selected search points of the macroblocks. A current macroblock that is sufficiently similar reference macroblock is then selected and paired together. Vectors denoting a displacement between each matching reference macroblock and each matching current macroblock are then determined. These vectors are known as motion vectors, and serve as a representation of the displacement between matching macroblocks from the reference frame to the current frame for use in the prediction process.

Using the reference frame and motion vectors, one can now reconstruct an approximation of the current frame (now the reconstructed frame) by copying the matching reference macroblock of the reference frame to the location noted by the corresponding motion vectors. This form of image reconstruction is also known as motion compensation. In this manner, subsequent frames can be continually predicted, without having to store redundant macroblocks from a current frame into memory. Certain macroblocks from the reconstructed frame are simply produced from a matching macroblock from a reference frame according to a motion vector. This process therefore compresses video sizes by omitting the storage of redundantly used macroblocks. The level of compression varies with the number of macroblocks replaced from frame to frame, and the desired image resolution.

The matching process in ME entails comparing selected pixels from a current macroblock with the same pixels from a reference macroblock using a cost function. A search algorithm provides the selection of search points indicating which pixels are to be used for comparison in the matching process. The cost function provides a value indicating the degree of similarity between the compared search points. One of the more common cost functions to determine the similarity between two input images includes the sum of absolute differences (SAD). The greater the similarity between the two inputs, the smaller the SAD value will result. The matching process in ME therefore uses a cost function to compare search points of a current macroblock to search points of a reference macroblock to determine the degree of similarity between the two macroblocks. If the cost value between the two macroblocks are sufficiently low, then the reference macroblock is suitable to replace the current macroblock in motion estimation.

The complete ME process is typically separated into two categories: integer ME and fractional ME (FME). The integer ME process should to be well known to someone in the related art, and therefore a concise description of this process is omitted for the sake of brevity. FIG. 1 details a typical search algorithm for the fractional ME process 100 according to the related art. The search algorithm 100 is used for selecting specific search points to be used for comparison in the matching process. The search process in fractional motion estimation is typically completed in two parts. The first part consists of half-pel motion estimation, where specific pels (pixels) at a half-pel spacing are searched for comparison. The second part consists of quarter-pel motion estimation, where pels at quarter-pel spacings centered around a search point obtained in the first part are used for comparison.

In the first part of half-pel ME, a cost value for each of eight search points 120 in a square search pattern surrounding an integer spaced pel search center 110 is calculated. A cost value calculation for the search center 110 is not performed. The single search point from the group of search points 120 possessing the lowest cost value is then selected as the quarter-pel motion estimation search center 130 in the next step. The quarter-pel motion estimation step utilizes an additional eight (quarter) search points 140 displaced around the FME search center 130 in a smaller square pattern. A total of 16 search points (8 search points from half-pel ME plus 8 search points from quarter-pel motion estimation) are therefore searched and compared in a single round of the traditional ME procedure according to the related art.

### SUMMARY OF THE INVENTION

A method for determining a search pattern for use in fractional motion estimation for video compression is disclosed. The method comprises selecting a search center within a current macroblock; selecting a plurality of search points forming a half-pel search pattern surrounding the search center, and further selecting another search point at the search center; calculating a cost value for each search point according to a first cost function; and selecting a quarter-pel search pattern according to the cost values of at least two search points, the half-pel search pattern and the quarter-pel search pattern forming the search pattern; wherein the search pattern is used in a matching process to determine a similarity of the current macroblock to a reference macroblock in a video undergoing compression.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the search algorithm according to the related art.

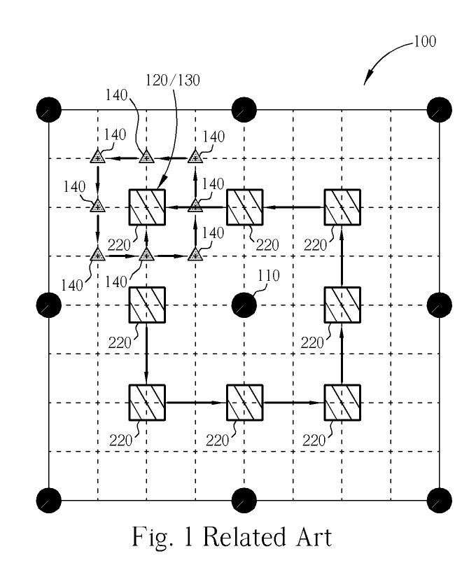

FIG. 2 is a diagram illustrating an embodiment of a half-pel search pattern according to the present invention.

FIG. 3 is a diagram illustrating a quarter-pel search pattern for case 1 according to the present invention.

FIG. 4 is a diagram illustrating a quarter-pel search pattern for case 2 according to the present invention.

FIG. 5 is a diagram illustrating a quarter-pel search pattern for case 3 according to the present invention.

FIG. 6 is a diagram illustrating a quarter-pel search pattern for case 4 according to the present invention.

FIG. 7 is a flowchart illustrating a method for determining a search pattern according to the present invention.

### DETAILED DESCRIPTION

Although the typical search algorithm for the ME process 100 does manage to sufficiently locate suitable search points for the motion vector refinement process, the excess amount of search points may result in significant delays in the encoding process. The typical search algorithm for the ME process 100 may possess too many search points to visit within one motion vector refinement process. Furthermore, the search pattern used in the ME process 100 may provide further constraints in finding optimal search points, as refinement in the fractional ME (or FME) searching can cause the search area to stray away from the search center.

In order to overcome these problems, and produce a more efficient search pattern, a fast FME search algorithm is proposed according to the present invention. This algorithm produces a search pattern based on the high statistical probability that fractional motion is located close to the integer search center. In this way, additional search points can be based near or on the integer search center. The second step of fractional ME can now take place in an optimized search area where the ideal search center may be located. This allows the complete FME process to be accomplished with fewer overall search points compared to the traditional method, while providing a comparable accuracy. Furthermore, the overall computational resources and complexity to search a predefined search area is greatly reduced.

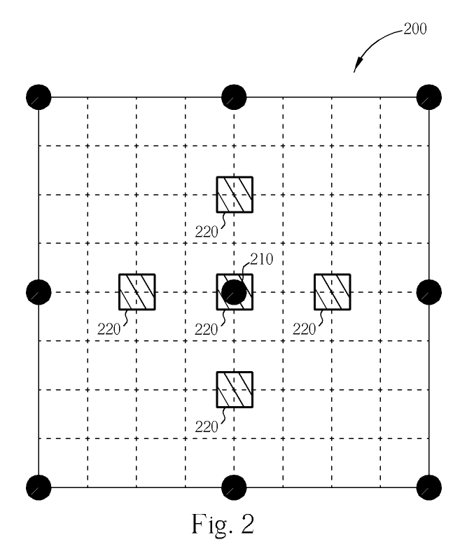

FIG. 2 illustrates a fast FME search algorithm according to the present invention. The algorithm is used to determine an optimized search pattern comprising a half-pel search pattern 200 and a quarter-pel search pattern (discussed later). An integer spaced pel 210, or search center is shown as a circle in the center of the macroblock in FIG. 2.

The search center is typically chosen as the integer spaced search point during the previous ME process having the best match in forming a motion vector with integer precision. Thus the process of FME is to further refine the motion vector to fractional precision. The first stage of the FME algorithm comprises half-pel FME, where the a half-pel search pattern is formulated. A total of 5 search points 220 are selected to form the half-pel search pattern: four search points aligned to form a cross pattern centered at the search center with one search point located at the search center. Additional embodiments may contain a different amount of search points. Once the half-pel search pattern has been determined, a cost value for each search point 220 is calculated. Any suitable cost function can be used in this step, however, the sum of absolute transform differences (SATD) is generally used for the FME process. The cost function is used to determine which of the search points 220 correspond to the lowest 2 (or 3) cost values. Upon determination of the search points 220 producing the lowest cost values, a quarter-pel search pattern for the fractional ME process is adaptively selected.

The next stage of the fast FME algorithm process entails selecting a quarter-pel search pattern. The quarter-pel search pattern is selected according to a ranking of cost values for each specific search point of the half-pel search pattern, and provides additional search points in a certain area to approach the global minimum cost in the search window. In an effort to reduce confusion, the search points deduced in the quarter-pel ME stage will be referred to as quarter-pel search points. However, both types of search points are fundamentally similar and serve the same purpose in providing matching points in the FME process to determine similarly matching macroblocks.

Once a quarter-pel search pattern is determined (further below), cost values for the quarter-pel search points of the quarter-pel search pattern are then calculated. The cost values attained here are used in conjunction with the cost data accumulated from search points in the first stage to determine whether the current macroblock is a suitable match to the reference macroblock. The entire FME search pattern therefore comprises the half-pel search pattern used in the first stage of FME and the quarter-pel search pattern used the second stage of FME.

The following cases illustrate how the quarter-pel search pattern is selected in the second stage of fractional ME. The quarter-pel search pattern is based on a ranking of the cost values for each search point in the first stage for half-pel ME. The cases are as follows:

Case 1: The lowest cost search point is located at the search center, and the second and third lowest search points are opposite to each other.

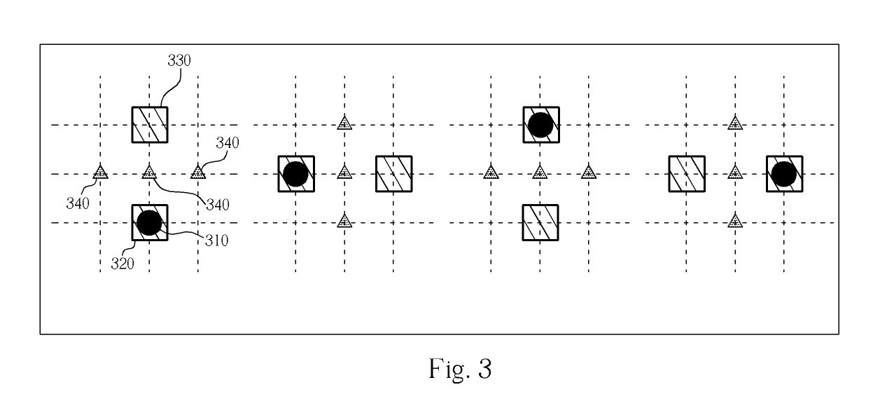

This case is illustrated in FIG. 3. In this case, the lowest cost search point 320 (from half-pel FME) is the located at the search center 310, and the second lowest cost search point 330 and third lowest cost search point (not shown) are opposite each other. For this case, three quarter-pel search points 340 placed between the minimum cost search point 320 and the second lowest cost search point 330 are selected as the quarter-pel search pattern in fractional ME. The three quarter-pel search points 340 are configured such that they form a straight line perpendicular to the axis formed by the lowest cost search point 320 and the second lowest cost search point 330, and are located in between the two half-pel search points 320 and 330.

Case 2: The lowest cost search point is located at the search center, and the second and third lowest cost search points are adjacent to each other.

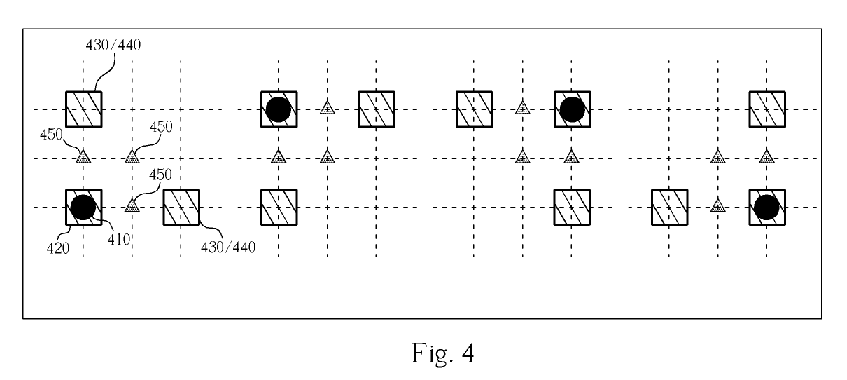

This case is illustrated in FIG. 4. The lowest cost search point 420 is located at the search center 410, and the second lowest cost search point 430 is adjacent to the third lowest cost search point 440. For this case, three quarter-pel search points 450 are used to form the quarter-pel search pattern in fractional ME. The three quarter-pel search points 450 are arranged between the three lowest cost search points such that a connection between the three quarter-pel search points 450 would from a right angle with the vertex of the right angle concave to the search center 410.

Case 3: The two lowest cost search points are adjacent to each other and surround the search center.

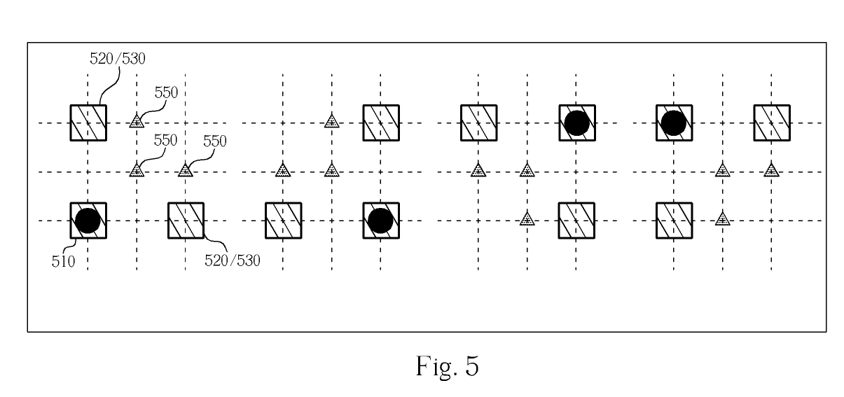

This case is illustrated in FIG. 5. The lowest cost search point 520 and the second lowest cost search point 530 are adjacent to each other and both surround the search center 510. For this case, three quarter-pel search points 550 are used to form the quarter-pel search pattern in fractional ME. The three quarter-pel search points 550 are arranged between the two lowest cost search points such that lines connecting the three quarter-pel search points 550 would from a right angle, with the vertex of the right angle convex to the search center 510.

Case 4: The two lowest cost search points are opposite to each other and surround the search center.

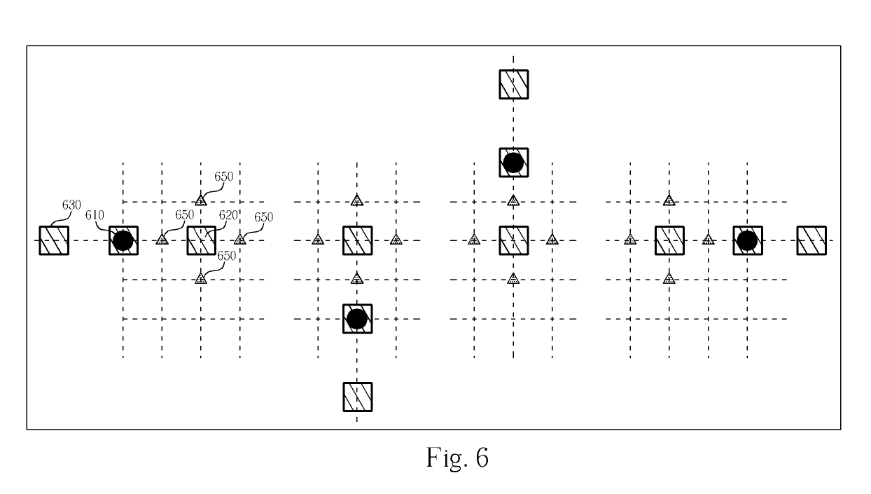

This case is illustrated in FIG. 6. The lowest cost search point 620 is opposite to the second lowest cost search point 630, neither being located at the search center 610. For this case, four quarter-pel search points 650 are used to form the quarter-pel search pattern in the quarter-pel step of FME. The quarter-pel search pattern is arranged such that the four quarter-pel search points 650 surround the lowest cost search point 620 in a cross pattern.

Once a quarter-pel search pattern is selected based on one of the 4 above cases, calculations for each quarter-pel search point using a specified cost function can be performed to complete the matching process. The total amount of search points include the search points used in the half-pel step of FME, and the quarter-pel search points in the quarter-pel step. The data provided from all of these search points serve to provide a comprehensive data set in an area approaching a local minimum of the cost function. This allows for a more accurate match result, while lowering the need for calculating additional search points. The best matching macroblock that minimizes the difference between the current and reference macroblock can now be chosen and used for the reconstruction process.

The following table provides a summary of the total search points used in the method of the present invention for each potential case, compared to alternative search algorithms for ME.

TABLE 1
Summary of Total Search Points

| | Total Search Points |
|---|---|
| Full Search Algorithm | 49 |
| Related Art Algorithm | 16 |

| | | |
|---|---|---|
| Algorithm of present | Case 1 | 8 |
| invention | Case 2 | 8 |
| | Case 3 | 8 |
| | Case 4 | 9 |

As illustrated above in Table 1, the search algorithm of the present invention for motion estimation significantly reduces the total search points in comparison with the related art. For cases 1-3, a 50% reduction in search points is attained, while a 43% reduction in search points is achieved in case 4. This significantly reduces the hardware processing required by a related compression encoder or a microprocessor for use in video compression.

Additionally the method of the present invention manages to arrive at a comparable matching accuracy while reducing the total search points and processing time. Table 2 below details the prediction accuracy of both the present invention algorithm and the related art algorithm. The prediction accuracies are measured as a hit rate of the search fractional motion vector in the y and x axis of the respective algorithm compared to the motion vector produced through the full search algorithm. We see that the algorithm of the related art manages to consistently produce a hit rate of around 90% for the various video samples. The algorithm of the related art produces a comparable hit hate of about 80%, while reducing the search points by roughly half.

TABLE 2
Hit rate of various algorithms compared to full search algorithm

| | | | Present invention | |
|---|---|---|---|---|
| | Related art algorithm | | algorithm | |
| | MV_x hit | MV_y hit | MV_x hit | MV_y hit |
| | rate | rate | rate | rate |
| Sample 1 | 0.95086006 | 0.94094485 | 0.81168958 | 0.84223568 |
| Sample 2 | 0.93886042 | 0.90366406 | 0.79969447 | 0.78225377 |
| Sample 3 | 0.9223743 | 0.88868022 | 0.82468642 | 0.82102286 |
| Sample 4 | 0.9759824 | 0.96602579 | 0.9272946 | 0.91579924 |
| Sample 5 | 0.9268235 | 0.94608455 | 0.77841821 | 0.84063553 |

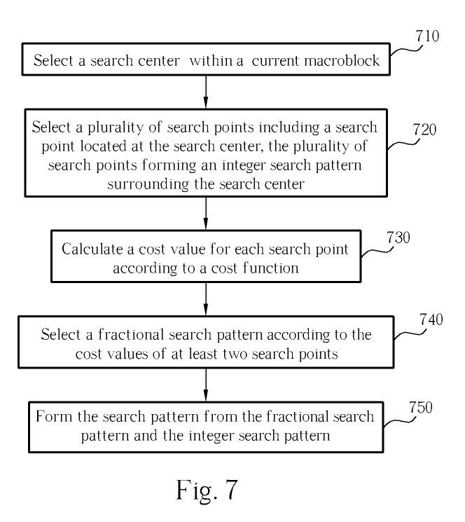

Referring to FIG. 7, the following steps summarize a method 700 used for determining a search pattern for use in fractional motion estimation for video compression according to the present invention. Provided that substantially the same result is achieved, the steps of the method 700 need not be in the exact order shown and need not be contiguous, that is, other steps can be intermediate. The method steps are as follows:

Step 710: select a search center within a current macroblock;

Step 720: select a plurality of search points including a search point located at the search center, the plurality of search points forming a half-pel search pattern surrounding the search center;

Step 730: calculate a cost value for each search point according to a cost function;

Step 740: selecting a quarter-pel search pattern according to the cost values of at least two search points; and

Step 750: forming the fractional search pattern from the half-pel search pattern and the quarter-pel search pattern.

By reducing the overall number of search points used in FME according to the present invention method, overall computational time and effort in video compression is greatly reduced. The algorithm described above provides an adaptive method to select an efficient search pattern that allows for further refinement in a low-cost region of the cost function. The fractional search pattern comprises two parts: a half-pel search pattern and a quarter-pel search pattern (comprising quarter-pel search points). The half-pel search pattern provides search points (including the search center) to identify an area or gradient approaching a local minimum of the cost function. Based on lowest cost values of at least two search points in the half-pel search pattern and their respective configuration, the quarter-pel search pattern is determined. The quarter-pel search pattern further refines the FME process by supplying additional search points (specifically quarter-pel search points) near the local minimum of the cost function. In this manner, cost values can be determined for several search points near the optimal area around the local minimum of the cost function.

The algorithm of the present invention allows for the determination of a search pattern with search points targeting the local minimum region of the cost function. This results in a more efficient operation for macroblock matching while retaining a comparable accuracy to prior methods.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining a search pattern for use in fractional motion estimation for video compression, the method comprising:
selecting a search center within a current macroblock;
selecting a plurality of search points including a search point located at the search center, the plurality of search points forming a half-pel search pattern surrounding the search center;
calculating a cost value for each search point according to a cost function; and
selecting a quarter-pel search pattern according to the cost values of at least two search points, the half-pel search pattern and the quarter-pel search pattern forming the search pattern;
wherein the search pattern is used in a matching process to determine a similarity of the current macroblock to a reference macroblock in a video undergoing compression.

2. The method of claim 1 wherein the quarter-pel search pattern comprises three quarter-pel search points aligned in a straight line perpendicular to a line connecting a lowest cost search point and a second lowest cost search point, the three quarter-pel search points being between the lowest cost search point and the second lowest cost search point.

3. The method of claim 1 wherein the quarter-pel search pattern comprises three quarter-pel search points arranged in between the three lowest cost search points, and lines connecting the three quarter-pel search points form a right angle concave to the search center.

4. The method of claim 1 wherein the quarter-pel search pattern comprises three quarter-pel search points arranged in between the two lowest cost search points, and lines connecting the three quarter-pel search points form a right angle convex to the search center.

5. The method of claim 1 wherein the quarter-pel search pattern comprises four quarter-pel search points arranged to surround a lowest cost search point in a cross pattern.

6. The method of claim 1 wherein selecting a quarter-pel search pattern according to the cost values comprises:
determining the three lowest cost search points;
when a lowest cost search point is located on the search center, and a second lowest cost search point and a third lowest cost search point are opposite to each other, selecting the quarter-pel search pattern as three quarter-pel search points aligned in a straight line perpendicular to a line connecting the lowest cost search point and the second lowest cost search point, the three quarter-pel search points being between the lowest cost search point and the second lowest cost search point;
when the lowest cost search point is located on the search center and the second lowest cost search point and the third lowest cost search point are adjacent to each other, selecting the quarter-pel search pattern as three quarter-pel search points arranged in between the three lowest cost search points and lines connecting the three quarter-pel search points form a right angle concave to the search center;
when the lowest cost search point and the second lowest cost search point are adjacent to each other and neither search point is located on the search center, selecting the quarter-pel search pattern as three quarter-pel search points arranged in between the two lowest cost search points and lines connecting the three quarter-pel search points form a right angle convex to the search center; and
when the lowest cost search point is opposite to the second lowest cost search point and the search center is between the two lowest cost search points, selecting the quarter-pel search pattern as four quarter-pel search points arranged to surround the lowest cost search point in a cross pattern.

7. The method of claim 1 further comprising using a sum of absolute differences (SAD) as the cost function.

8. The method of claim 1 further comprising using a sum of absolute transform differences (SATD) as the cost function.

9. The method of claim 1 further comprising utilizing a total of five search points for the half-pel search pattern.

10. The method of claim 9 wherein the plurality of search points comprises a search point above the search center, a search point below the search center, a search point left of the search center, and a search point right of the search center.

11. The method of claim 1 further comprising using an integer spaced search point from integer motion estimation having a best match in forming a motion vector with integer precision as the search center.
